(19) United States
(12) Patent Application Publication
(10) Pub. No.: US 2011/0004833 A1
(43) Pub. Date: Jan. 6, 2011

(54) Regulatory Task Management System and Method

(76) Inventors: Robert Lang, Williamsport, PA (US); Russell Shanahan, State College, PA (US); Scott Marino, Williamsport, PA (US); Steve Valette, State College, PA (US)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 12/575,935

(22) Filed: Oct. 8, 2009

Related U.S. Application Data
(60) Provisional application No. 61/222,589, filed on Jul. 2, 2009.

(51) Int. Cl. G06F 9/46; G06F 3/01

(52) U.S. Cl. 715/760; 718/100

(57) ABSTRACT

A user may review a web-based document (including, but not limited to, at least one of a regulation and a notice of changes to a regulation) and determine that the web-based document indicates that some action must be taken. By utilizing a script or a task management system, a user may create a task that is to be added to a task management system to address the action that must be taken.

### CROSS-REFERENCE TO CO-PENDING APPLICATIONS

The present application is related to and claims priority to U.S. Provisional Application Ser. No. 61/222,589 filed Jul. 2, 2009, the contents of which are incorporated herein by reference.

### FIELD OF THE INVENTION

The present invention is directed to a method and system for creating a component of a workflow system from a graphical user interface, and in one embodiment to a method and system for adding tasks to a task management system while reviewing a web-based document.

### DISCUSSION OF THE BACKGROUND

The Federal Register publishes changes and proposed changes with respect to various agencies and the regulations that specify the operations of those various agencies. Electronic versions of the information from the Federal Register can be found on certain governmental and non-governmental web sources. Other jurisdictions (e.g. local, state and federal governments) as well as information aggregators also provide electronic versions of regulations. “Regulations” as used herein includes local, state and federal regulations as well as statutes and administrative procedures (e.g., the Manual of Patent Examination Procedures).

### BRIEF DESCRIPTION OF THE DRAWINGS

The following description, given with respect to the attached drawings, may be better understood with reference to the non-limiting examples of the drawings, wherein:

FIG. 1 is a screenshot of an exemplary web browser for reviewing a web-based document and which enables a workflow task to be created while performing the review;

FIG. 2 is a screenshot of an exemplary task entry system for entering a task into a workflow management system having requested that a new task be created (e.g., using the interface of FIG. 1);

FIG. 3 is a screenshot of an exemplary task tracking system for tracking the progress and/or status of a task entered using a task entry system (e.g., using the interface of FIG. 2);

FIG. 4 is a screenshot of an exemplary web browser for reviewing a web-based document and which enables a workflow task to be created (for a new or existing workflow) while performing the review;

FIG. 5 is a screenshot of an exemplary dialog box for performing authentication of a user in order to control who may add tasks to a particular workflow and/or browse the corresponding web-based document;

FIG. 6 is a screenshot of an exemplary custom application including a browser window for reviewing a web-based document and which enables a workflow task to be created while performing the review;

FIG. 7 is a screenshot of an exemplary custom application including a browser window for reviewing a web-based document and which enables a workflow task to be created (for a new or existing workflow) while performing the review;

FIG. 8 is a screenshot of an exemplary web browser for reviewing a web-based document and which indicates whether a workflow task has been created for the web-based document;

FIG. 9 is a block diagram of a browser application communicating with a task management system including at least one workflow management system where tasks are added to the workflow management system, either directly or via a back-end server; and

FIG. 10 is a screenshot of an exemplary interface for showing and/or modifying a workflow.

### DISCUSSION OF THE PREFERRED EMBODIMENTS

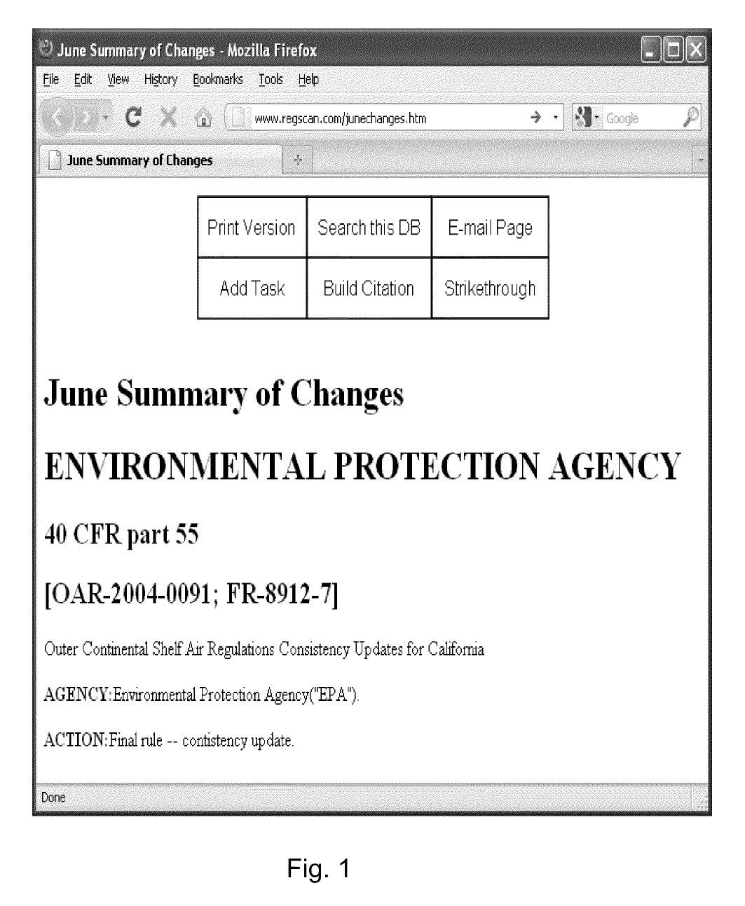

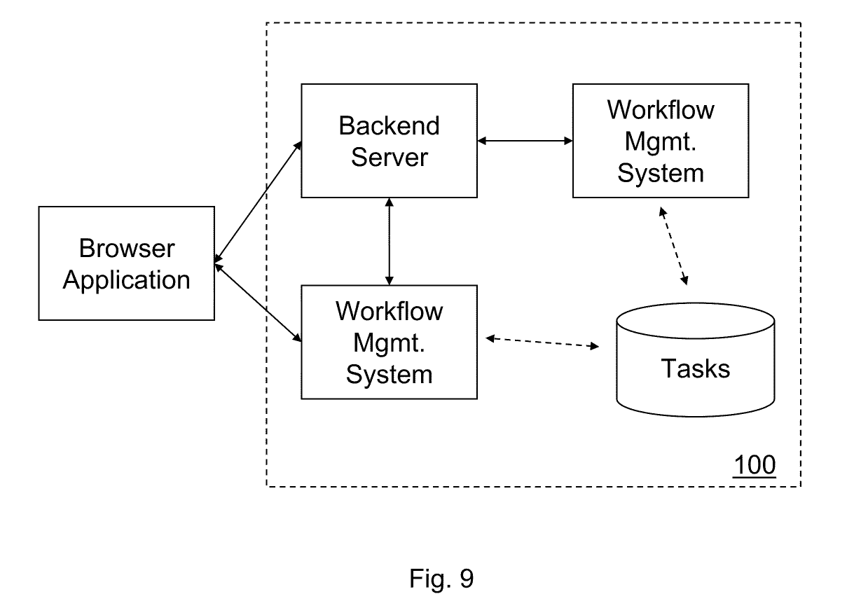

As shown in FIG. 1, a user may review a web-based document (including at least one of a regulation and a notice of changes to a regulation) and determine that the web-based document indicates that some action must be taken. (As used herein, a “web-based document” is a document that can be loaded via a web browser, whether the document is stored on a private, local network separate from the Internet or on a network accessible by the Internet.) Web-based documents include HTML documents, word processor documents, PDF documents, spreadsheet documents, and XML-based documents. For example, when reviewing a notice of a change to a regulation (such as “Outer Continental Shelf Air Regulations Consistency Update for California”), the user may determine that the user or the user's company must perform a specific action (e.g., in order to stay in compliance with one or more regulations) or that a new opportunity exists (e.g., when a request for proposals or comments is released). As such, in the illustrated exemplary interface, the user would click on the “Add Task” control (e.g., an image or button at near the top of the user interface) in order to indicate that a new task is to be created. The control (e.g., using hypertext or a script) enables the web browser to communicate with a script or a task management system 100 (FIG. 9) upon activation of the control to perform the “Add Task” functionality.

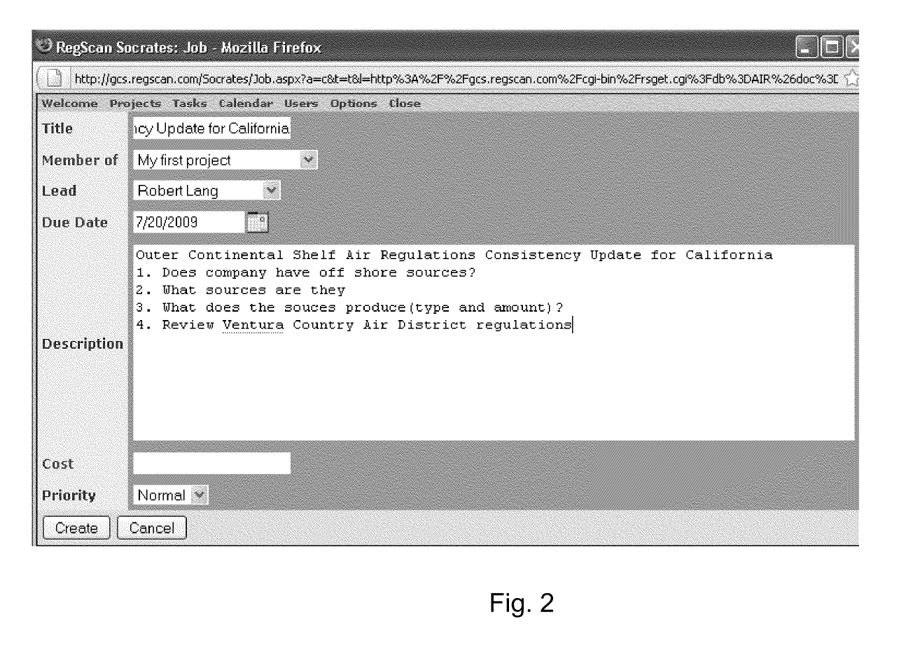

As shown in FIG. 2, when the “Add Task” control has been selected, the web browser creates a new form interface that can be filled out with the information that makes up the task to be added. This new form interface can be generated within the web browser (e.g., using a script loaded into the page having the “Add Task” control) or by communicating with a task management system 100 as shown in FIG. 9. The task management system may be either a workflow management system or a server that is designed to create tasks or “events” to be added to an off-the-shelf or custom workflow management system. In the latter embodiment, the data for creating the task or event may be exported into a standard form (e.g., a standard XML format) that can be automatically imported into the workflow management system with the workflow management system providing the conversion from the standard form into the internal form of the workflow management system. Alternatively, in an embodiment where a user can identify (e.g., as part of his/her login profile) his/her type of workflow management system, the script or back-end server can generate the task or event in the native format of the specified workflow management system. The browser, however, may communicate with more than one workflow management system and/or back-end server, depending on the web-based document being reviewed.

In one embodiment, a user is required to manually fill out each of the fields of the task before submitting the task to the task management system 100. In an alternate embodiment, the original hypertext (e.g., the hypertext for creating the interface of FIG. 1) is supplemented with information about which document or what portion of a document the user is reviewing. For example, the hypertext that causes to be displayed the image bar that allows the user to select the various actions to be performed (e.g., print, search, email and add a task), can be supplemented with a page identifier which uniquely identifies the document or the portion of the document that is being viewed (e.g., the regulation or the regulation change that is being reviewed). In an embodiment using a script, the script adds appropriate information to at least one of the fields of a web-based form. In an embodiment using a task management system 100 directly, when the browser contacts the task management system 100 directly, the browser sends the supplemental information which enables the task management system 100 to add appropriate information to at least one of the fields of the web-based form. For example, as shown in FIG. 2, the title field can be automatically added to the form by the script or the task management system 100 if the title information (or information from which the title can be fetched) is added to the original hypertext and is therefore used and/or passed on with the request to add a task.

Using the interface generated by a script or received from the task management system 100, the user then could describe the task to be completed (e.g., give it a title, describe action(s) to be performed, assign the task to a user, and set a due date, priority level and/or cost associated with the task). In one embodiment, a portion of the task management system 100 assigns a unique identifier to the task (so that the task can be tracked in the future) and returns the unique identifier to the web browser as part of the indication that the task has been successfully sent or added to the workflow management system.

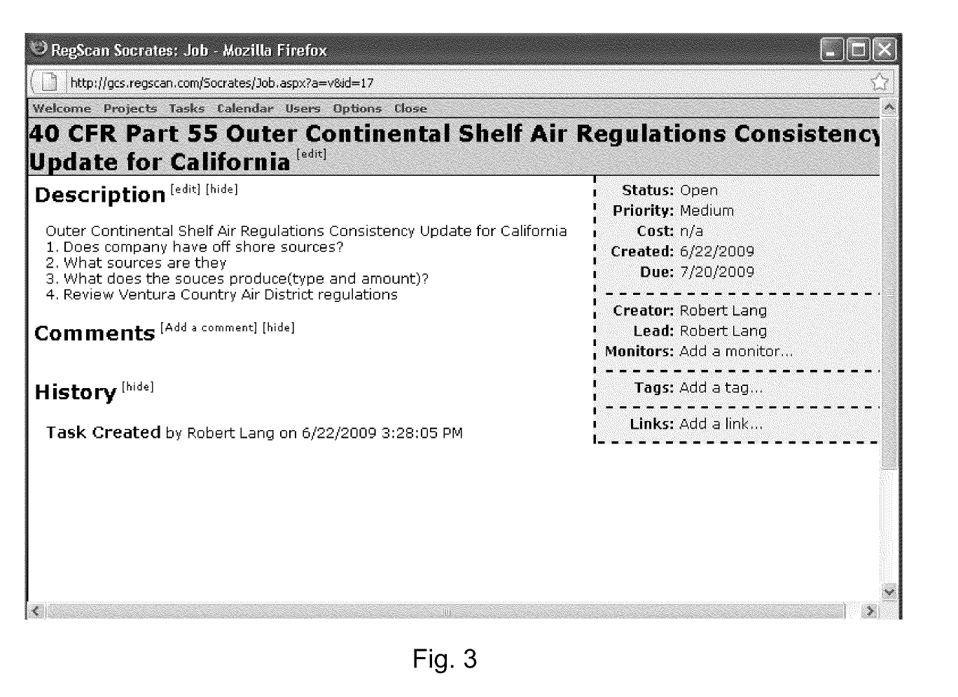

As shown in FIG. 3, once a task has been entered into the task management system 100, the status of the task can be monitored by querying the task management system 100 with information about the task (e.g., using a unique identifier or other search criteria such as a keyword in the description or title). The system 100 then returns a user interface to a browser that shows at least the status of the task. In one embodiment, the user is also allowed to add classification information and/or additional details which become part of the documentation on the process review.

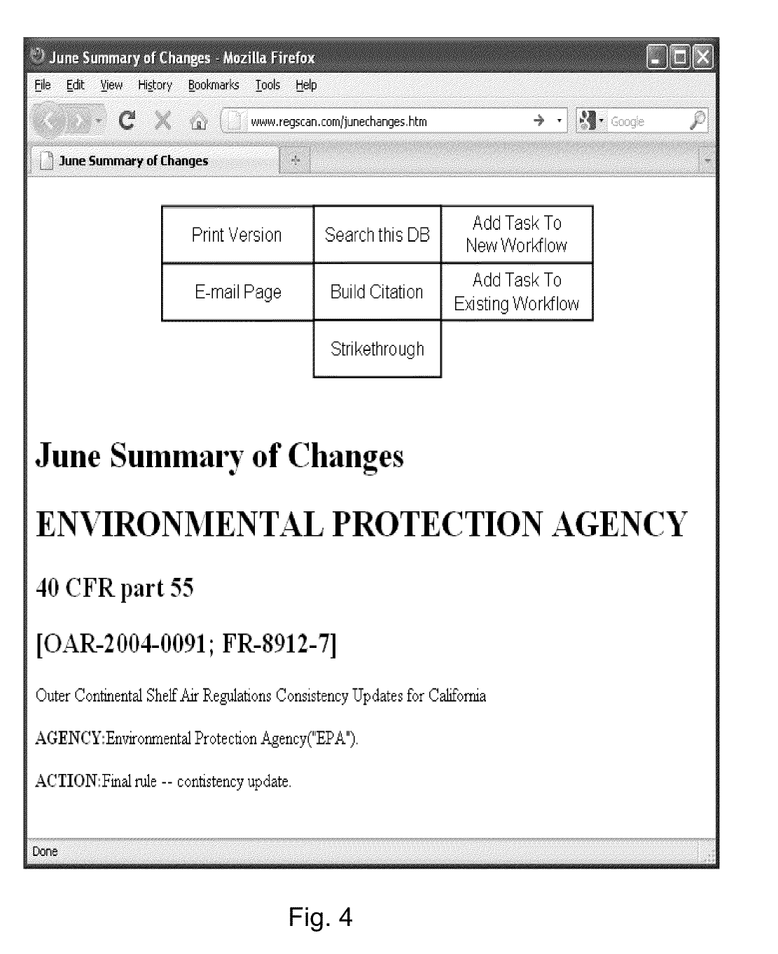

As shown in FIG. 4, an alternate web-browser based implementation can enable the user to specify whether the task to be added is a task for a new workflow or for an existing workflow. In such an embodiment, if the task is for a new workflow, the user may be prompted to specify a name for the new workflow. However, if the new task is for an existing workflow, then the user may be requested to specify to what workflow the task is to be added and where in the workflow process it is to be added.

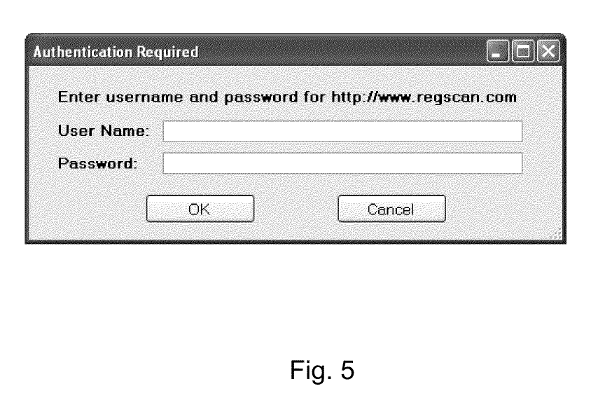

In order to ensure that only authorized users can add tasks to a workflow management system, the workflow management system may require that a user is authenticated (e.g., using a username and password as shown in FIG. 5). In at least one embodiment, other identification information (e.g., a web browser ‘cookie’ or other token or IP address) may also be used to identify or specify any one or a combination of: a user, a user's license number, and/or the user's rights to perform the various actions that can be performed by the system.

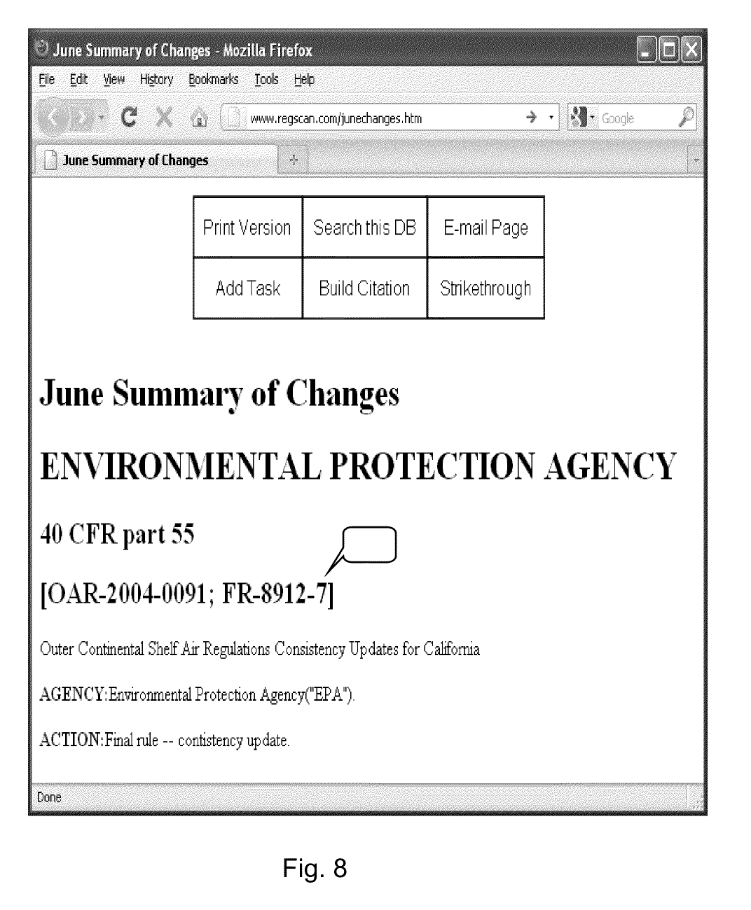

In one embodiment of the present invention, an interface for reviewing the web-based documents may further include an indication (e.g., a flag, note or annotation) of whether there is a task pending for the web-based document being reviewed. For example, as shown in FIG. 8, a balloon callout indicates that task information is available about the regulation change being reviewed. If a query of the workflow management system indicates that the task has been completed, a later loading of the web-based document would no longer have the task indication on the web-based document.

In an alternate embodiment using an interface (e.g., the interface of FIG. 1) where the user interface does not specify whether the task to be added is for a new or existing workflow, in response to a request to add a new task, the workflow management system may send back an interface that allows a user to specify as part of the other information about the task whether the task is for a new or existing workflow. In fact, the workflow management system may query its records (e.g., using a local or remote database) to determine the names of the existing workflows and provide the list of valid names as part of the user interface. The system may also provide a list of all outstanding tasks for a particular web-based document (e.g., for a particular regulation). The list of tasks may be filtered to show only those tasks which are open and only for the users within the same group of users. The list of tasks further may be sortable using one or more fields and/or displaying one or more attributes about the task. For example, a list of tasks may show each task and for example is associated project and its owner. Furthermore, a user may select a task and the system will respond by showing all other tasks which reference the same regulation either singularly or together. This will allow, for example, all citations to be linked by project and other variations of fields.

In addition to adding a task for a single user, the present invention may be utilized with groups of users as well. For example, a user (e.g., a group administrator) may specify the names or other identifiers of users that are to be combined into a group. For example, using the interface of FIG. 2, a user can select the “Users” menu item to specify the members of a group. Furthermore, the interface of FIG. 2 may be supplemented with a text box or other control (e.g., a drop-down box) that allows the name of an existing group to be selected. Then, upon addition of a new task, each of the members of the group would be notified of the new task.

To facilitate additions to the group, the system may further include a set of rules which allow non-administrators to add themselves to groups as well. For example, if an authenticatable parameter (e.g., license #, organization ID, domain or IP address) of a user requesting to be added to a group matches one of the corresponding entries in the rules database, then the system may assume that the user is authorized to be added, and the addition is performed.

In an environment where multiple users wish to operate collectively, the system can additionally provide for changes in which user is responsible for performing a task that has been created. For example, if user1 were to create a task (referred to as “task1”) while reviewing the web-page of FIG. 1, user1 may later specify that user2 is to become responsible for task1, even though it was created by user1. User1 may additionally indicate to the system whether or not user 1 is to continue receiving updates on the status of task1 (such that user 1 becomes a manager of task1 but not its implementer) or if task1 has been relinquished to user2.

In such a cooperative environment, a group of users with interest in a task may be defined such that the users of the group may make comments on a task and make changes to a task. To provide for accountability, the system may also provide audit trails such that the system can generate reports on who made additions, changes and/or comments.

In one embodiment of a task management system 100, the task management system 100 may provide additional security services for the tasks that are created and/or managed by the task management system 100. For example, the tasks and/or workflows may be stored in the task management system 100 in encrypted form. When the browser requests that a task or a workflow be reviewed or edited, the browser may receive an encrypted task or workflow and automatically decrypt the received task or workflow to provide greater security of the communications between the browser and the task management system 100. In yet another embodiment, an encrypted communications channel (e.g., secure sockets) can be used to increase security of the communications between the browser and the task management system 100.

In addition to adding tasks for particular web-based documents, the system may also be configured to create “watch lists” (either manually or automatically when a task is added) which cause a user to be notified when the information related to a web-based document changes. For example, while a construction project is underway, a user may create a watch list related to the regulations governing the transportation of hazardous materials needed for the project. Then, if the regulation(s) added to the watch list change during the pendency of the project, a user of the system can be notified such that appropriate action can be taken (e.g., materials can be shipped in a new way). When a user later ends a project, the user may eliminate the watch list to avoid receiving further updates. The notifications may be in various forms, such as an email indicating that a change has occurred, a visual or audio indication on the web-based document the next time the web-based document is loaded, or the automatic addition of a new task that is “review change to watch list item.” For convenience, watch lists may be named and/or renamed by a user to have a human-understandable name, and watch list items may be moved from one watch list to another.

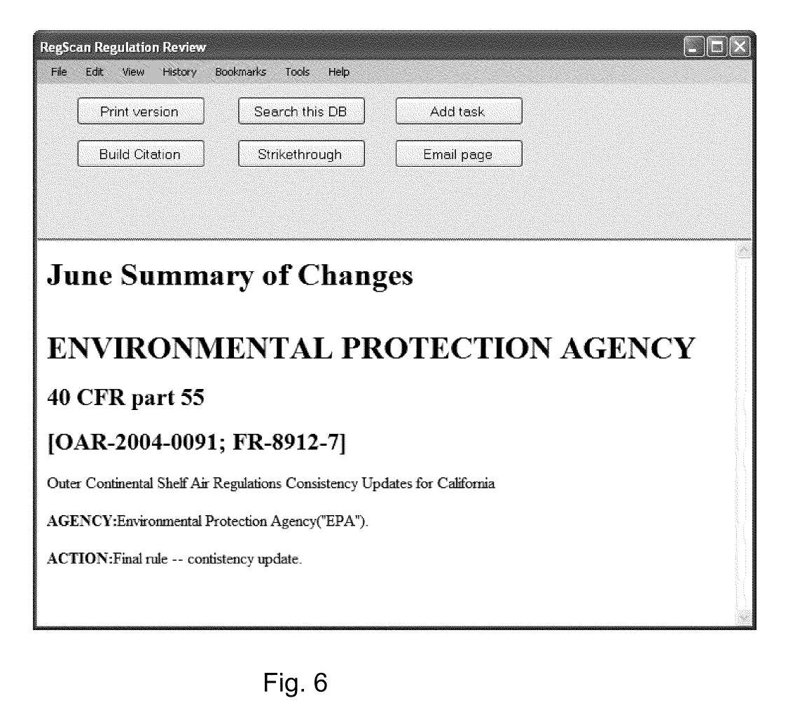

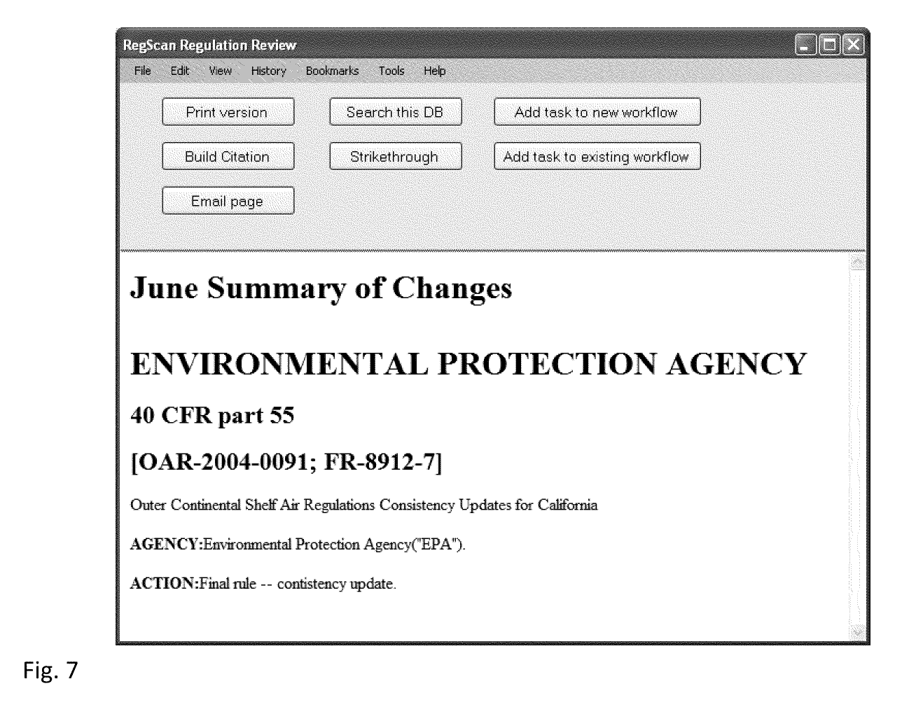

While the above description has been provided with respect to a system and method using a conventional web browser, it is also possible to use a custom application (e.g., with action buttons separate from the web browser window) that includes a web browser window but includes one or more additional controls (e.g., for performing task management functions). Two other exemplary interfaces are shown in FIGS. 6 and 7. Generally, both a web browser implementation and a custom application will be referred to herein as browsing applications. Such browsing applications may be implemented in software operating on a general purpose machine or may be a combination of special-purpose hardware and software. Software within the browsing application is stored in a computer memory and executed by a processor reading that memory. Such a memory may include RAM or non-volatile memory (e.g., Flash Memory, Ferroelectric-RAM (FRAM) and battery-backed up RAM). The software may additionally be stored on a physical computer-readable medium (e.g., a hard-drive, a solid-state drive, an optical medium (e.g., a CD, DVD, HD-DVD or a Blu-ray disc) which stores the software to be executed by the processor prior to being loaded into memory of the system. The browser application may communicate with remote computers using a communications adapter that can be a wireless or a wired communications adapter. Wireless adapters include, but are not limited to, adapters according to the 802.11 family of standards (including 802.11a, 802.11b, 802.11g, 802.11n), WiMax, and cell-phone based data transmission standards. Wired adapters include, but are not limited to, Ethernet adapters, ATM adapters, token-ring adapters.

In yet another embodiment, a user may additionally create a task simply by going to a web-page that includes one or more entry boxes and using those entry boxes to specify a particular subject (e.g., a particular regulation section) for which a task is to be created. For example, a could specify that he/she wants to create a task related to OSHA_{—}29_CFR such that the users or other users in his/her group can quickly find the task based on a known task naming convention.

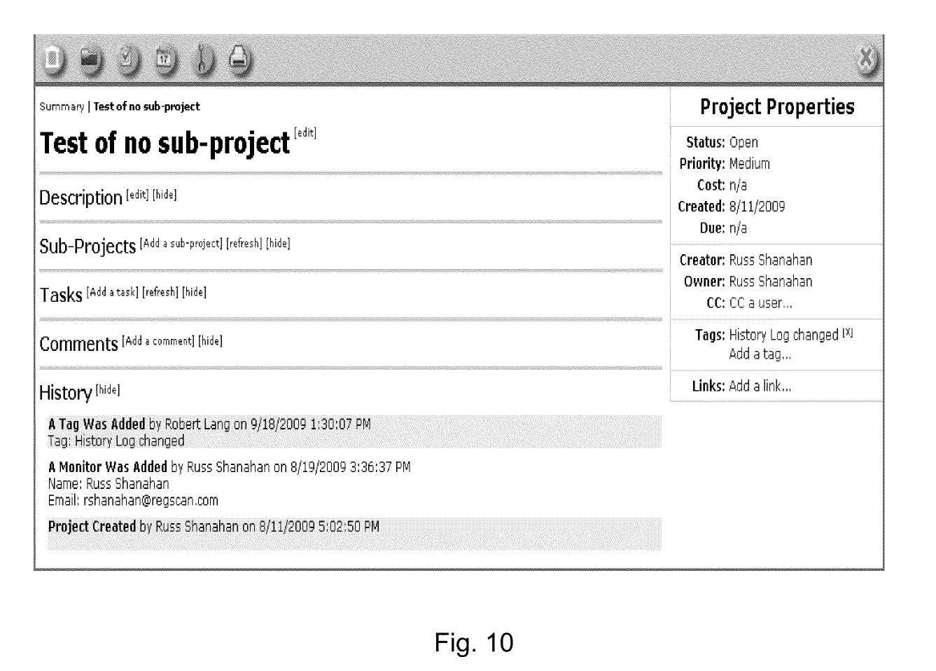

In yet a further embodiment, a user may wish to build a task from another task or a task template. All information in the other task or task template would be copied except for the history information (i.e., the log of changes made to the task) when copied. The newly built task would receive an initial history log entry that indicates that the newly built task was made at a particular date/time (e.g., using a timestamp) by a particular user (e.g., retrieved from log-in information) and copied from another task or template (referred to as the “source task”). The source task would be linked to the newly built task, and if the user wanted to view details of the source task he/she could do so by just clicking a link. Fields such as title, description, due date, owner could be edited/changed, and, as with other tasks described above, all changes are logged. When the copy is made one or more fields are automatically copied and updated, such as the creation date, the history log. One exemplary interface for tracking a workflow is shown in FIG. 10. Any document to be associated with a task would be copied and attached to the corresponding task. Documents that are attached and stored will be stored in an encrypted state (e.g., within a relational database data structure or in a file system), and the system will automatically encrypt and decrypt the document when the user works with the document

As described above, a task management system is described using a methodology which is the reverse of a conventional system. Conventional systems are based on incidents that have occurred or specific events that require tasks to be completed. On the contrary, the above method and system enables users to generate tasks from the regulations that govern their operations or lives.

While certain configurations of structures have been illustrated for the purposes of presenting the basic structures of the present invention, one of ordinary skill in the art will appreciate that other variations are possible which would still fall within the scope of the appended claims.

We claim:

1. A system for adding tasks to a workflow management system, comprising:
a computer memory;
a processor;
a communications adapter; and
a browser application stored in the computer memory and executed by the processor to load a web-based document, create a task for a workflow management system related to information contained in the web-based document, and send the task, using the communications adapter, to the workflow management system for addition by the workflow management system.

2. The system as claimed in claim 1, wherein the web-based document is an HTML document relating to a regulation.

3. The system as claimed in claim 1, wherein the web-based document is an HTML document relating to a change in a regulation.

4. The system as claimed in claim 1, wherein statuses of tasks added to the workflow management system can be queried.

5. The system as claimed in claim 1, wherein the browser application indicates on the web-based document whether a task has been created by a user for the web-based document.

6. The system as claimed in claim 1, further comprising a task management system for storing a list of plural users that form a group, wherein the browser application indicates on the web-based document whether a task has been created by a user of the group for the web-based document.

7. The system as claimed in claim 6, wherein the task management system adds a user to a group based on at least one of a license number, an organization ID, a domain name, and an IP address.

8. The system as claimed in claim 1, wherein the browser application is configured to change a user responsible for completing the task from a user that created the task to another user.

9. The system as claimed in claim 1, further comprising a task management system for tracking changes related to the web-based document and notifying a user of a change in the web-based document.

10. A method of adding tasks to a workflow management system, comprising:
storing a browser application in a computer memory;
executing by a processor the steps of:
loading a web-based document,
create a task for a workflow management system related to information contained in the web-based document, and
sending the task, using a communications adapter, to the workflow management system for addition by the workflow management system.

11. The method as claimed in claim 10, wherein the web-based document is an HTML document relating to a regulation.

12. The method as claimed in claim 10, wherein the web-based document is an HTML document relating to a change in a regulation.

13. The method as claimed in claim 10, wherein statuses of tasks added to the workflow management system can be queried.

14. The method as claimed in claim 10, wherein the browser application indicates on the web-based document whether a task has been created by a user for the web-based document.

15. The method as claimed in claim 10, further comprising storing a list of plural users that form a group in a task management system, wherein the browser application indicates on the web-based document whether a task has been created by a user of the group for the web-based document.

16. The system as claimed in claim 15, wherein the task management system adds a user to a group based on at least one of a license number, an organization ID, a domain name, and an IP address.

17. The method as claimed in claim 10, wherein the browser application is configured to change a user responsible for completing the task from a user that created the task to another user.

18. The method as claimed in claim 10, further tracking, in a task management system, changes related to the web-based document and notifying a user of a change in the web-based document.
